(19) United States
(12) Patent Application Publication
(10) Pub. No.: US 2005/0184538 A1
(43) Pub. Date: Aug. 25, 2005

(54) Lock assembly having improved mounting cap and spindle combination

(76) Inventors: Tsung-Chung Huang, Chiayi County (TW); Ju-Lin Yang, Chiayi County (TW); Lan-Kun Don, Chia-Yi City (TW); Chen-Ming Lin, Chiayi County (TW); Sheen-Youl Gao, Yu-Lin County (TW)

Correspondence Address: LADAS & PARRY LLP, 224 SOUTH MICHIGAN AVENUE, SUITE 1600, CHICAGO, IL, 60604, US

(21) Appl. No.: 11/062,032

(22) Filed: Feb. 18, 2005

(30) Foreign Application Priority Data
Feb. 20, 2004 (TW) 093202537

(51) Int. Cl. E05B 3/00

(52) U.S. Cl. 292/336.3

(57) ABSTRACT

A lock assembly includes a mounting cap with a spindle hole, a spindle extending through the spindle hole, and a rotary knob connected to the spindle. The spindle may be moved axially so as to be locked against rotational movement relative to the mounting cap. In a preferred embodiment, the mounting cap and the spindle are provided respectively with interengageable first and second engaging elements. A retaining element is mounted on the mounting cap to releaseably and selectively engage first and second shoulder faces formed on the spindle so as to retain the spindle in two positions.

### CROSS-REFERENCE TO RELATED APPLICATION

This application claims priority from Taiwanese Utility Model Application No. 93202537 filed on Feb. 20, 2004.

### BACKGROUND OF THE INVENTION

1. Field of the Invention

This invention relates to a door lock, more particularly to a lock assembly which is mountable inside a door.

2. Description of the Related Art

A lock assembly which is mounted on the inside of a door typically includes a manually operable knob (A) and a mounting cap (B) as shown in FIGS. 1 and 2. The mounting cap (B) is mountable on an inner side of the door and has a spindle hole (not shown), whereas the knob (A) is connected integrally to a rotary spindle (c) which extends through the spindle hole and the door panel. A C-shaped ring (D) is used to retain the spindle on the mounting cap (B), The knob (A) may be turned to place the lock assembly in a locking position or an unlocking position. In such a lock assembly, even when the lock assembly is placed in its locking position by turning the knob (A) from the inside of a door, the lock assembly may be actuated to reach the unlocking position by using a key from the outside of the door.

### SUMMARY OF THE INVENTION

An object of the present invention is to provide a lock assembly with an improved mounting cap and spindle combination so that, when a door is locked with the lock assembly from the inside of the door, the door cannot be unlocked from the outside of the door.

According to one aspect of the present invention, a lock assembly comprises: a mounting cap having a spindle hole and a first engaging element proximate to the spindle hole; a spindle extending through the spindle hole and including a second engaging element; a rotary knob connected to the spindle and being operable to move the spindle between a first position in which the first and second engaging elements are interengaged to lock the spindle against rotational movement relative to the mounting cap and a second position in which the first and second engaging elements disengage from each other to permit rotation of the spindle.

According to another aspect of the present invention, a lock assembly comprises: a mounting cap having a spindle hole; a spindle extending through the spindle hole and including two axially spaced apart first and second retention parts formed on a periphery of the spindle; a retaining element mounted on the mounting cap proximate to the spindle to engage releaseably and selectively one of the first and second retention parts; and a rotary knob operable to move axially the spindle between a position in which the retaining element engages the first retention part and another position in which the retaining element engages the second retention part.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a schematic view of a conventional lock assembly which is mountable on an inside of a door;

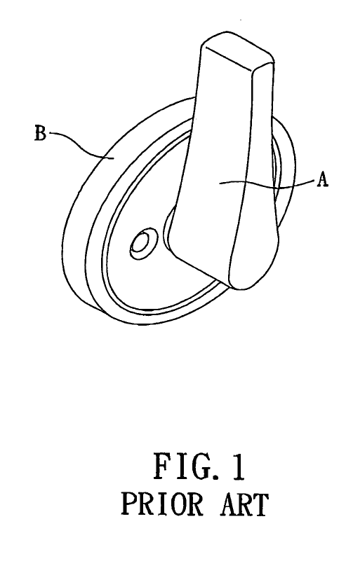

FIG. 2 is an elevation view of the conventional lock assembly of FIG. 1;

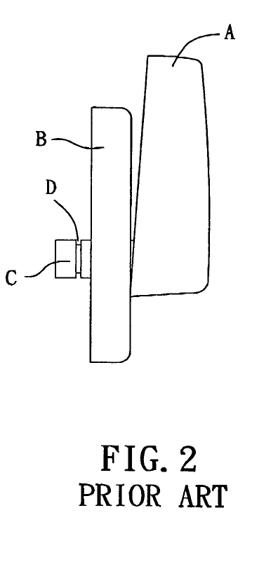

FIG. 3 is an exploded view of a lock assembly embodying the present invention;

FIG. 4 is a perspective view of the lock assembly of FIG. 3;

FIG. 5 is another perspective view of the lock assembly of FIG. 3; and

FIG. 6 is the same view as FIG. 5 but with a rotary knob being turned to a locking position.

### DETAILED DESCRIPTION OF THE PREFERRED EMBODIMENT

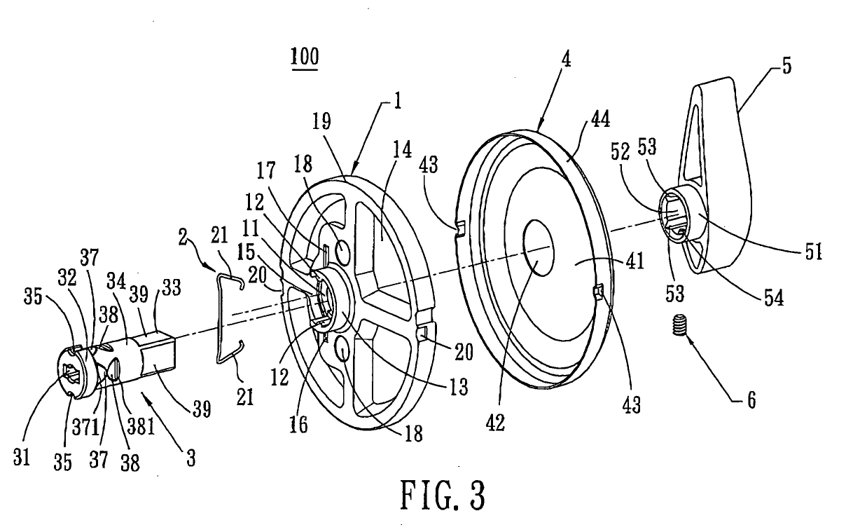

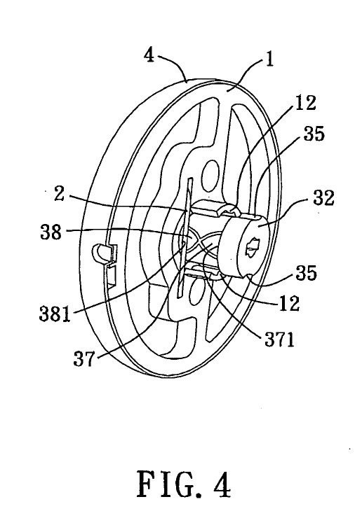

Referring to FIGS. 3 and 4, there is shown a lock assembly 100 embodying the present invention. The lock assembly 100 comprises a mounting cap 1 which includes a base wall 14 formed with a spindle hole 11, and a curved flange 13 projecting axially from the base wall 14 around the spindle hole 11. A first engaging element is provided on the curved flange 13 and is preferably formed as two diametrically opposed protrusions 12. The curved flange 13 is substantially rounded and has a notch 15. A retaining element which is preferably formed as a spring rod 2 is provided in the vicinity of the notch 15. The spring rod 2 has two bent fixing ends 21 respectively secured to two fixing holes 16, 17 formed in the base wall 14. The base wall 14 of the mounting cap 1 further has two through holes 18 for extension of two fasteners (not shown) therethrough. An annular rim 19 projects axially from an outer periphery of the base wall 14 and has two diametrically opposed indentations 20.

A spindle 3 which has a varying cross-section extends through the spindle hole 11 of the mounting cap 1. The spindle 3 includes an outer section 32, an inner section 33 and an intermediate section 34 interconnecting the outer and inner sections 32, 33. An axial insert slot 31 is formed in the outer section 32 for insertion of a turning shaft (not shown) which is used to operate a door latch (not shown). The outer section 32 is provided with a second engaging element which preferably includes two diametrically opposed recesses 35 formed on an annular surface of the outer section 32 for engagement with the respective protrusions 12. The inner section 33 of the spindle 3 has four flat sides 39.

According to the present invention, the intermediate section 34 is provided with axially spaced apart first and second retention parts. In this embodiment, the first and second retention parts include four pairs of axially spaced apart first and second shoulder faces 371, 381 (only two pairs are shown in FIG. 3) which extend substantially circumferentially. The four pairs of the first and second shoulder faces 371, 381 are spaced apart angularly at equal intervals. Two juxtaposed slanting surfaces 37, 38 are disposed between each pair of the first and second shoulder faces 371, 381. The slanting surfaces 37, 38 slant oppositely and respectively toward the corresponding first and second shoulder faces 371, 381. The spring rod 2 extends transversely of the intermediate section 34 of the spindle 3 to releaseably and selectively engage one of the corresponding first and second shoulder faces 371, 381.

A cap cover 4 which is in the form of a disc includes a hole 42 formed in a base wall 41 for alignment with the spindle hole 11, and a surrounding wall 44 extending around the annular rim 19 of the mounting cap 1. The surrounding wall 44 has two diametrically opposed locking elements 43 to interlock respectively with the indentations 20 of the annular rim 19.

A rotary knob 5 has a hollow shaft 51 which defines a slot 52 to receive the inner section 33 of the spindle 3, and four grooves 53 (only two are shown) in communication with the slot 52 for engagement with the inner section 33. A screw hole 54 is formed radially in the hollow shaft 51 in communication with the slot 52.

In assembly, the spindle 3 extends through the spindle hole 11 and is retained on the mounting cap 1 by the spring rod 2 which is in engagement with one of the first and second shoulder faces 371, 381 as best shown in FIG. 4. The mounting cap 1 is adapted to be mounted on an inside of a door (not shown) and to be coupled with an outer lock assembly (not shown) disposed at an outside of the door by using two fasteners (not shown) that extend through the throughholes 18, respectively. The cap cover 4 is connected to the mounting cap 1 by interengagement of the indentations 20 and the locking elements 43.

A clamping screw 6 is threaded into the screw hole 54 of the hollow shaft 51 to engage the inner section 33 of the spindle 3, thereby connecting the rotary knob 5 to the spindle 3.

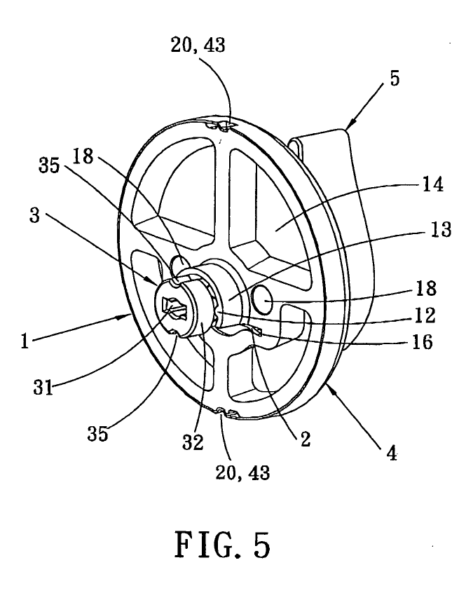

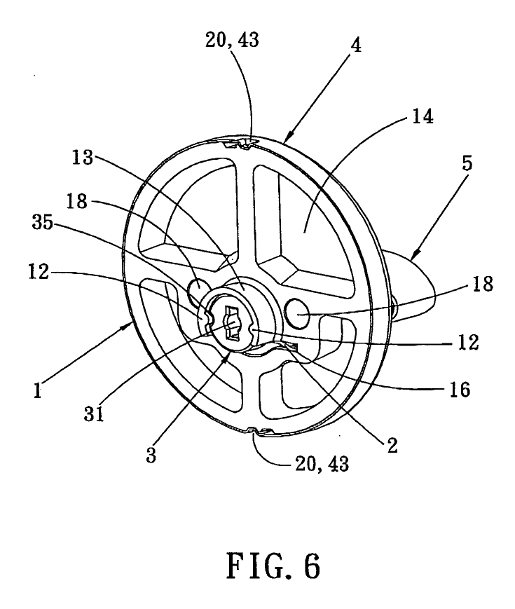

In use, a key (not shown) may be inserted into the outer lock assembly (not shown) which is coupled with the lock assembly 100 to operate place a door latch (not shown). Furthermore, the rotary knob 5 can be turned by an angle of about 90 degrees to move between a position shown in FIG. 5 and another position shown in FIG. 6 so as to unlock or lock the door. When the rotary knob 5 is in the position shown in FIG. 6, the spindle 3 may be moved axially between a first position (see FIG. 6) in which the protrusions 12 engage the respective recesses 35 to lock the spindle 3 against rotational movement relative to the mounting cap 1 and a second position in which the protrusions 12 disengage from the respective recesses 35 to permit rotation of the spindle 3.

When the rotary knob 5 is pushed outward and turned to the position shown in FIG. 5, the outer section 32 is moved outwardly of and disengaged from the curved flange 13 so that the spindle 3 is rotatable relative to the mounting cap 1. In this state, the spring rod 2 is engaged with the second shoulder face 381 as shown in FIG. 4 so as to retain resiliently the spindle 3 on the mounting cap.

When the rotary knob 5 is turned by 90 degrees from the position shown in FIG. 5 and then pulled inward, the outer section 32 is moved into the curved flange 13, as shown in FIG. 6, so that the spindle 3 is locked against rotational movement relative to the mounting cap 1. Furthermore, the spring rod 2 disengages from the second shoulder face 381 and engages the first shoulder face 371. To this end, the first and second slanting surfaces 37, 38 permit the spring rod 2 to slide from the second shoulder face 381 to the first shoulder face 371. In this state, even if a key is used to operate the outer lock assembly (not shown) from the outside of the door, the spindle 3 cannot be rotated so that the door cannot be unlocked from the outside of the door. The door can be unlocked only when the rotary knob 5 is pressed to disengage the recesses 35 from the protrusions 12.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

1. A lock assembly for a door, comprising:
a mounting cap having a spindle hole and a first engaging element proximate to said spindle hole;
a spindle extending through said spindle hole and including a second engaging element;
a rotary knob connected to said spindle and being operable to move said spindle between a first position in which said first and second engaging elements are interengaged to lock said spindle against rotational movement relative to said mounting cap and a second position in which said first and second engaging elements disengage from each other to permit rotation of said spindle.

2. The lock assembly as claimed in claim 1, wherein said mounting cap further includes a curved flange extending substantially around said spindle hole, said spindle including an inner section connected to said rotary knob and an outer section opposite to said inner section, said rotary knob being operable to move axially said outer section into or out of said curved flange.

3. The lock assembly as claimed in claim 2, wherein said first engaging element is formed on said curved flange, said second engaging element being formed on said outer section of said spindle, said second engaging element being engageable with said first engaging element when said outer section is moved into said curved flange.

4. The lock assembly as claimed in claim 3, wherein said first and second engaging elements are respectively formed as a recess and a protrusion which are interengageable.

5. The lock assembly as claimed in claim 2, further comprising a retaining element mounted on said mounting cap proximate to said curved flange, said spindle further including an intermediate section interconnecting said outer and inner sections, said intermediate section including axially spaced-apart first and second retention parts, said retaining element being releaseably engageable with said first retention part when said outer section is moved into said curved flange and with said second retention part when said outer section is moved out of said curved flange.

6. The lock assembly as claimed in claim 5, wherein said first and second retention parts are formed respectively as first and second shoulder faces which are formed in a periphery of said intermediate section in an axially spaced apart relationship.

7. The lock assembly as claimed in claim 6, wherein said retaining element includes a spring rod disposed adjacent said curved flange and extending transversely of said intermediate section to engage releaseably said first or second shoulder face.

8. The lock assembly as claimed in claim 7, wherein said spindle further includes two juxtaposed slanting surfaces between said first and second shoulder faces, said slanting surfaces slanting oppositely and respectively toward said first and second shoulder faces.

9. A lock assembly, comprising:
a mounting cap having a spindle hole;
a spindle extending through said spindle hole and including two axially spaced apart first and second retention parts formed on a periphery of said spindle;
a retaining element mounted on said mounting cap proximate to said spindle to engage releaseably and selectively one of said first and second retention parts; and
a rotary knob operable to move axially said spindle between a position in which said retaining element engages said first retention part and another position in which said retaining element engages said second retention part.

10. The lock assembly as claimed in claim 9, wherein said first and second retention parts are formed respectively as first and second shoulder faces which are spaced apart axially and which extend substantially circumferentially.

11. The lock assembly as claimed in claim 10, wherein said retaining element includes a spring rod extending substantially transversely of said spindle to engage said first or second shoulder face.

12. The lock assembly as claimed in claim 11, wherein said spindle further includes two juxtaposed slanting faces between said first and second shoulder faces, said slanting faces slanting oppositely and respectively toward said first and second shoulder faces.

13. A lock assembly comprising:
a mounting cap adapted to be mounted on an inside of a door and having a spindle hole;
a spindle extending through said spindle hole and including an inner section, said spindle being rotatable to place the lock assembly in a locking or unlocking position; and
a rotary knob connected to said inner section,
wherein said spindle is movable axially to a position in which said spindle is locked against rotational movement relative to said mounting cap.
